(19) United States
(12) Patent Application Publication
(10) Pub. No.: US 2026/0062274 A1
(43) Pub. Date: Mar. 5, 2026

(54) CONCENTRATED SPIRIT BEVERAGE, STORING AND DISPENSING SYSTEM THEREFOR, AND METHOD

(71) Applicant: WilCraft Can, LLC, Oak Creek, WI (US)

(72) Inventor: Sean P. Kingston, Oak Creek, WI (US)

(73) Assignee: WilCraft Can, LLC, Oak Creek, WI (US)

(21) Appl. No.: 18/819,210

(22) Filed: Aug. 29, 2024

(51) Int. Cl. B67D 1/00; C12G 3/06

(52) U.S. Cl. CPC B67D 1/0021; C12G 3/06

(57) ABSTRACT

A concentrated spirit beverage composition comprises a consumable alcohol; a consumable sugar; water; and optionally, one or more natural flavorings, artificial flavorings and particulate matter, wherein the concentrated spirit beverage composition is substantially free of preservatives. The concentrated spirit beverage may be provided in a container, such as a container with a bag-in-a-box configuration. A portion of the concentrated spirit beverage is diluted with a consumable liquid to prepare a spirit beverage. The portion of the concentrated spirit beverage may be portioned using, for example, a soda gun. Using a bag-in-a-box container configuration and soda gun dispenser allows for efficient serving of spirit beverages and mitigates concerns over storage and spoilage or additional ingredients.

### FIELD OF THE INVENTION

The present disclosure relates to beverage concentrates, and more particularly to a concentrated spirit beverage, storing and dispensing systems therefor, and related methods.

### BACKGROUND

Mixed cocktails, or mixed drinks comprising a spirit, are known. To prepare such drinks fresh, ingredients such as juice, bitters, soda, syrups, spirits (alcohol), and potentially other liquids or solids dissolved in liquid, are measured and mixed in a proper ratio. This process takes time and has the potential to create back-ups at busy bars. The process also requires training and is prone to inconsistencies, as each ingredient is measured by eye/hand by different people. This can result in flavor or taste variances at and between locations.

To help alleviate these and other concerns, some establishments will pre-mix batch cocktails or at least batch base mixes so that only alcohol and/or dilutants need to be added prior to serving. While improving serving time and drink consistency, pre-mixing cocktails or bases comes with their own difficulty. Many of these pre-mixes include perishable ingredients and only last a day or two in the refrigerator before deteriorating.

Many cocktails also require perishable ingredients, such as juices and syrups. These ingredients, when not fully used, must be discarded and replaced. These ingredients are also provided in their “ready-to-use” form. That is, these ingredients contain a quantity of water, while a concentrated ingredient eliminates an amount of water and therefore takes up less room on shelves. Alternatively, establishments may stock only a limited selection of perishable ingredients and therefore offer a limited cocktail menu.

To help alleviate these and other concerns, some establishments will pre-mix batch cocktails or at least batch base mixes so that only alcohol and/or dilutants need to be added prior to serving. While improving serving time and drink consistency, pre-mixing cocktails or bases comes with their own difficulty. Many of these pre-mixes include perishable ingredients and only last a day or two in the refrigerator before deteriorating. Alternatively, preservatives can be added at the expense of taste/quality.

Accordingly, it would be desirable to provide a mix for a spirit beverage that alleviated or addressed one or more of the above-discussed concerns. It would be desirable to provide a mix for spirit beverages that alleviated or addressed one or more other concerns or disadvantages, or provided one or more advantages by comparison with existing spirit beverages.

It would be desirable to provide a storing and/or dispensing system for spirit beverages, and related methods, that alleviated or addressed one or more of the above-discussed concerns. It would be desirable to provide a storing and/or dispensing system for spirit beverages, and related methods, that alleviated or addressed one or more other concerns or disadvantages, or provided one or more advantages by comparison with existing spirit beverages, storing and/or dispensing systems, and related methods.

### BRIEF SUMMARY

A concentrated spirit beverage composition is disclosed herein. A concentrated spirit beverage composition comprises a consumable alcohol; a consumable sugar; water; and optionally, one or more natural flavorings, artificial flavorings and particulate matter, wherein the concentrated spirit beverage composition is substantially free of preservatives.

In embodiments, the consumable alcohol is present in an amount from greater than or equal to 10 vol % to less than or equal to 70 vol %, or from 15 vol % to 65 vol %. In an embodiment, the consumable sugar is present in an amount from greater than 5 vol % to 50 vol %. In an embodiment, the water is present in an amount from greater than 0 vol % to less than or equal to 55 vol %.

In an embodiment, the composition comprises less than 0.1 vol % preservatives, or 0 vol % preservatives. In an embodiment, the composition has a pH from greater than 1 to less than 9.

In an embodiment, the consumable alcohol is present in an amount from 15 vol % to 60 vol % and the consumable sugar is present in an amount from greater than 5 vol % to 50 vol %, or the consumable alcohol is present in an amount from 20 vol % to 60 vol % and the consumable sugar is present in an amount from greater than 5 vol % to 45 vol %, or the consumable alcohol is present in an amount from 25 vol % to 60 vol % and the consumable sugar is present in an amount from greater than 5 vol % to 45 vol %, or the consumable alcohol is present in an amount from 30 vol % to 60 vol % and the consumable sugar is present in an amount from greater than 5 vol % to 45 vol %.

In an embodiment, the composition comprises at least one natural or artificial flavoring. The natural or artificial flavoring is present in an amount from greater than 0 vol % to 25 vol %. In some embodiments, the artificial flavoring is citric acid and is present in an amount from greater than 0 vol % to 25 vol %, or 0 vol % to less than 2 vol %. In some embodiments, the natural or artificial flavoring comprises a natural fruit juice concentrate in an amount from 5 vol % to 20 vol %.

Disclosed herein is a method of making a spirit beverage. In an embodiment, the method comprises providing a concentrated spirit beverage, the concentrated spirit beverage comprising a consumable alcohol, a consumable sugar, water, and optionally, one or more of a natural flavoring, an artificial flavoring, and particulate matter; dispensing a portion of the concentrated spirit beverage; and diluting the portion of the concentrated spirit beverage with a consumable liquid.

In embodiments, the portion of the concentrated spirit beverage is diluted with the consumable liquid at a ratio of 2:1 (consumable liquid:concentrated spirit beverage) to 15:1 (consumable liquid:concentrated spirit beverage). In embodiments, the spirit beverage has an alcohol by volume (ABV) of greater than 0% to less than 10%, the concentrated spirit beverage has a consumable alcohol content of from 15 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 15:1 (consumable liquid:concentrated spirit beverage); or the spirit beverage has an ABV of 10% to less than or equal to 15%, the concentrated spirit beverage has a consumable alcohol content from 20 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 6:1 (consumable liquid:concentrated spirit beverage); or the spirit beverage has an ABV of 15% to less than or equal to 25%, the concentrated spirit beverage has a consumable alcohol content from 30 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 4:1 (consumable liquid:concentrated spirit beverage).

In embodiments, the concentrated spirit beverage is connected to a consumable beverage dispenser for dispensing.

### DETAILED DESCRIPTION

Unless stated to the contrary, implicit from context, or customary in the art, all parts and percents are based on volume. The terms “comprising,” “including,” “having” and their derivatives are not intended to exclude the presence of any additional component, step or procedure, whether or not the same is specifically disclosed. In order to avoid any doubt, all compositions claimed through use of the term “comprising” may include any additional additive, adjuvant, or compound unless stated to the contrary. In contrast, the term “consisting essentially of” excludes from the scope of any succeeding recitation any other component, step or procedure, excepting those that are not essential to operability. The term “consisting of” excludes any component, step or procedure not specifically delineated or listed.

The numerical ranges in this disclosure include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 5; 1 to 6; 1 to 7; 2 to 5; 2 to 6; 2 to 7; 3 to 5; 3 to 6; 3 to 7; etc.).

In embodiments of the present disclosure, a concentrated spirit beverage is provided. The concentrated spirit beverage comprises consumable alcohol, consumable sugar, water, and, optionally, one or more of artificial flavorings, natural flavorings, and particulate matter, wherein the concentrated spirit beverage is substantially free of preservatives.

### Consumable Alcohol

In embodiments, the concentrated spirit beverage contains consumable alcohol. As used herein, “consumable alcohol” refers to alcohol that is intended to be consumed by humans. The alcohol present in the concentrated spirit beverage may be any form or spirits traditionally used in the creation of spirit-containing cocktails. In an embodiment, the alcohol present in the concentrated spirit beverage is derived from at least one of grains, vegetables, fruits, or other fermented ingredients. In a particular embodiment, the alcohol is derived from at least one of corn, potatoes, agave, wheat, rye, barley, grapes, sugar, sugarcane, and combinations thereof. That is, in a particular embodiment, the alcohol is selected from the group consisting of distilled corn spirits, distilled potato spirits, distilled agave spirits, distilled wheat spirits, distilled rye spirits, distilled barley spirits, distilled grape spirits, distilled sugar spirits, distilled sugarcane spirits, and combinations thereof.

In an embodiment, the consumable alcohol content of the concentrated spirit beverage is from greater than or equal to 10 percent by volume (vol %) to less than or equal to 70 vol %. In an embodiment, the consumable alcohol content of the concentrated spirit beverage is present from 10 percent by volume (vol %), or 15 vol %, or 20 vol %, or 25 vol %, or 30 vol %, or 35 vol %, or 40 vol %, or 45 vol % to 50 vol %, or 55 vol %, or 60 vol %, or 65 vol %, or 70 vol %. In an embodiment, the consumable alcohol content of the concentrated spirit beverage is from 15 vol %, or 20 vol %, or 25 vol %, or 30 vol %, or 35 vol %, or 40 vol % to 50 vol %, or 55 vol %, or 60 vol %, or 65 vol %.

In an embodiment, the consumable alcohol content of the concentrated spirit beverage depends on the desired alcohol content of the final (diluted) spirit beverage at the time of consumption. In an embodiment, the desired alcohol content of the final (diluted) spirit beverage at the time of consumption is from 2% alcohol by volume (ABV) to 14% ABV and the consumable alcohol content of the concentrated spirit beverage is from 15 vol %, or 20 vol %, or 25 vol %, or 30 vol % to 40 vol %, or 45 vol %, or 50 vol %, or 55 vol %, or 60 vol %. In an embodiment, the desired alcohol content of the final (diluted) spirit beverage at the time of consumption is from greater than 14% ABV to 20% ABV and the consumable alcohol content of the concentrated spirit beverage is from 25 vol %, or 30 vol %, or 35 vol %, or 40 vol % to 50 vol %, or 55 vol %, or 60 vol %.

In a further embodiment, the consumable alcohol content of the concentrated spirit beverage can be further linked to the alcohol content of the final (diluted) spirit beverage at the time of consumption. In an embodiment, the alcohol content of the final (diluted) spirit beverage at the time of consumption is from 2% ABV to less than 10% ABV and the alcohol content of the concentrated spirit beverage is from 15 vol %, or 16 vol %, or 17 vol %, or 18 vol %, or 19 vol %, or 20 vol %, or 25 vol %, or 30 vol % to 40 vol %, or 45 vol %, or 50 vol %, or less than or equal to 60 vol %. In an embodiment, the alcohol content of the final (diluted) spirit beverage at the time of consumption is from greater than or equal to 10% ABV to less than or equal to 15% ABV and the alcohol content of the concentrated spirit beverage is from 20 vol %, or 22 vol %, or 24 vol %, or 26 vol %, or 28 vol %, or 30 vol % to 40 vol %, or 45 vol %, or 50 vol %, or less than or equal to 60 vol %. In an embodiment, the alcohol content of the final (diluted) spirit beverage at the time of consumption is from greater than 15% ABV to less than or equal to 25% ABV and the alcohol content of the concentrated spirit beverage is from 30 vol %, or 32 vol %, or 34 vol %, or 36 vol %, or 38 vol %, or 40 vol % to 45 vol %, or 50 vol %, or 55 vol %, or 60 vol %, or less than or equal to 65 vol %.

### Consumable Sugar

In embodiments, the concentrated spirit beverage contains consumable sugar. As used herein, “consumable sugar” refers to sugar that is present in the concentrated spirit beverage and intended to be consumed by humans. “Consumable sugar” encompasses sugars or sweeteners which are added and any sugars which are part of a consumable alcohol or a fruit or other flavoring component.

The consumable sugar may be any natural sugar intended for human consumption. The consumable sugar may a natural sugar selected from glucose, fructose, galactose, sucrose, lactose, maltose, any other natural sugar composed of any combination of the monomers glucose, fructose and galactose, and combinations thereof.

In an embodiment, the consumable sugar content of the concentrated spirit beverage is from greater than or equal to 5 vol % to less than or equal to 50 vol %. In an embodiment, the consumable sugar content of the concentrated spirit beverage is present from greater than or equal to 5 vol %, or 10 vol %, or 15 vol %, or 20 vol %, or 25 vol % to 30 vol %, or 35 vol %, or 40 vol %, or 45 vol %, or 50 vol %. In an embodiment, the consumable sugar content of the concentrated spirit beverage is from greater than 5 vol %, or 10 vol %, or 15 vol %, or 20 vol % to 30 vol %, or 35 vol %, or 40 vol %.

In an embodiment, the consumable sugar content of the concentrated spirit beverage depends on the desired alcohol content of the final (diluted) spirit beverage at the time of consumption. In an embodiment, the desired alcohol content of the final (diluted) spirit beverage at the time of consumption is from 2% alcohol by volume (ABV) to 14% ABV and the consumable sugar content of the concentrated spirit beverage is from greater than or equal to 0 vol %, or vol %, or 10 vol %, or 15 vol %, or 20 vol %, or 25 vol % to 30 vol %, or 35 vol %, or 40 vol %, or 45 vol %, or 50 vol %. In an embodiment, the desired alcohol content of the final (diluted) spirit beverage at the time of consumption is from greater than 14% ABV to 20% ABV and the consumable sugar content of the concentrated spirit beverage is from greater than or equal to 5 vol %, or 10 vol %, or 15 vol %, or 20 vol %, or 25 vol % to 30 vol %, or 35 vol %, or 40 vol %, or 45 vol %.

### Water

In embodiments, the concentrated spirit beverage contains water. As used herein, “water” refers to water that has been filtered or purified to remove potential contaminants that could cause spoiling or fouling of the concentrated spirit beverage. Water is used to create the right volume and adjust the concentration of consumable alcohol and consumable sugar, and any other optional ingredients, in the concentrated spirit beverage.

In an embodiment, the water content of the concentrated spirit beverage is from greater than 0 vol %, or 5 vol %, or 10 vol %, or 15 vol %, or 20 vol %, or 25 vol % to 30 vol % or 35 vol %, or 40 vol %, or 45 vol %, or 50 vol %, or less than or equal to 55 vol %.

### Natural and Artificial Flavorings and Sweeteners

In embodiments, the concentrated spirit beverage may contain one or more natural flavorings. As used herein, “natural flavoring” refers to a flavor compound or mixture of flavor compounds derived from a natural consumable (e.g., food) source, such as fruits, vegetables, herbs, spices, etc. Exemplary natural flavorings include, but are not limited to, naturally-derived fruit juices, naturally-derived concentrated fruit juices, naturally-derived vegetable juices, naturally-derived concentrated vegetable juices, naturally-derived extracts, naturally-derived oils, naturally-derived emulsions, naturally-derived pastes, sap, nectar, honey, and combinations of these and other natural flavorings.

In embodiments, the concentrated spirit beverage may contain one or more artificial flavorings. As used herein, “artificial flavorings” refers to a synthetic chemical compound or mixture of synthetic chemical compounds that mimic a natural flavor. Exemplary artificial flavorings include, but are not limited to, fruit flavors and concentrates, vegetable flavors and concentrates, extracts, oils, emulsions, and pastes, all chemically manufactured or otherwise not based on an extraction from a natural source, and combinations of these and other artificial flavorings.

A natural or artificial flavoring may be used alone or in combination with one or more additional natural or artificial flavorings to create a flavor profile for the concentrated spirit beverage.

In an embodiment, the total natural or artificial flavoring content of the concentrated spirit beverage is from greater than 0 vol %, or 0.25 vol %, or 0.5 vol %, or 0.75 vol %, or 1 vol %, or 1.25 vol %, or 1.5 vol %, or 1.75 vol %, or 2 vol % to 2.25 vol %, or 2.5 vol %, or 2.75 vol %, or 3 vol %, or 3.5 vol %, or 4 vol %, or 5 vol %, or 6 vol %, or 7 vol %, or 8 vol %, or 9 vol %, or 10 vol %, or 15 vol %, or 20 vol %, or 25 vol %.

In a particular embodiment, the natural or artificial flavoring comprises citric acid. In an embodiment the natural or artificial flavoring comprises citric acid, and the citric acid is present in the concentrated spirit beverage in an amount from greater than 0 vol %, or 0.2 vol %, or 0.4 vol %, or 0.6 vol %, or 0.8 vol % to 1.0 vol %, or 1.2 vol %, or 1.4 vol %, or 1.6 vol %, or 1.8 vol %, or less than 2.0 vol %.

In a particular embodiment, the natural or artificial flavoring comprises a natural fruit juice concentrate. In an embodiment, the natural or artificial flavoring comprises a natural fruit juice concentrate, and the natural fruit juice concentrate is present in the concentrated spirit beverage in an amount from 5 vol %, or 6 vol %, or 7 vol %, or 8 vol %, or 9 vol %, or 10 vol % to 11 vol %, or 12 vol %, or 13 vol %, or 14 vol %, or 15 vol %, or 16 vol %, or 17 vol %, or 18 vol %, or 19 vol %, or 20 vol %.

In embodiments, the concentrated spirit beverage may contain one or more artificial sweeteners. Such artificial sweeteners are selected from acesulfame potassium, advantame, aspartame, neotame, saccharin, sucralose, luo han guo (monk fruit), purified stevia leaf extracts, and combinations thereof.

### Consumable Particulate Matter

In embodiments, the concentrated spirit beverage may contain particulate matter. As used herein, “consumable particulate matter” refers to non-liquid material in the concentrated spirit beverage that contribute to taste, flavor, texture or other property of the concentrated spirit beverage. Particulate matter may be non-dissolvable portions of the consumable sugar, non-dissolvable portions of the natural or artificial sweeteners, or a separately added non-liquid material. Nonlimiting examples of particulate matter in the concentrated spirit beverage include, but are not limited to, pulp, rind, zest, plant matter (e.g., flesh, herbs, spices), seeds, floral pieces, nuts, and combinations of these and other consumable particulate matter.

### pH

In an embodiment, the pH of the concentrated spirit beverage is balanced based on the specific spirit beverage being made. In general, the pH of the concentrated spirit beverage is from greater than 1 to less than 9. More particularly, the pH of the concentrated spirit beverage is from greater than 1, or 1.5, or 2, or 2.5, or 3, or 3.5, or 4, or 4.5 to 5, or 5.5, or 6, or 6.5, or 7, or 7.5, or 8, or 8.5, or 9. In still further embodiments, the pH of the concentrated spirit beverage is from greater than or equal to 2, or greater than or equal to 3, or greater than or equal to 4 to less than or equal to 5, to less than or equal to 6, or less than or equal to 7, or less than or equal to 8.

### Substantially Free of Preservatives

In embodiments, the concentrated spirit beverage is substantially free of preservatives. As used here, a “preservative” is a substance or chemical added to prevent spoiling, decomposition and/or microbial growth, or otherwise prevent chemical changes of the components of the concentrated spirit beverage. “Preservative” does not include compounds or substances which are naturally occurring in the consumable alcohol, consumable sugar, or natural or artificial flavorings, even if such compounds or substances have a preservative effect. Exemplary preservatives are those commonly used in the beverage industry including, but not limited to, salts, parabens, sulfur dioxide, sulfites, phosphoric acid, sorbates, benzoates, and combinations thereof.

As used herein, the term “substantially free of” means the concentrated spirit beverage contains less than 1 vol %, or less then 0.5 vol %, or less than 0.25 vol %, or less than 0.2 vol %, or less than 0.1 vol %, or less than 0.05 vol % to 0 vol % of preservatives. In a particular embodiment, the concentrated spirit beverage contains less than 0.1 vol %, or less than 0.09 vol %, or less than 0.08 vol %, or less than 0.07 vol %, or less than 0.06 vol %, or less than 0.05 vol %, or less than 0.04 vol %, or less than 0.03 vol %, or less than 0.02 vol %, or less than 0.01 vol % to 0 vol %.

In an embodiment, the concentrated spirit beverage is free of preservatives, meaning there is no measurable preservative added to the concentrated spirit beverage.

### Concentrated Spirit Beverage

A concentrated spirit beverage as disclosed herein comprises a consumable alcohol, a consumable sugar, water, and optionally, one or more natural flavorings, artificial flavorings and particulate matter, wherein the concentrated spirit beverage is substantially free of preservatives. In an embodiment, a concentrated spirit beverage has one, some or all of the following characteristics:
a. a consumable alcohol content from 15 vol % to 60 vol %;
b. a consumable sugar content from greater than 5 vol % to 45 vol %; and
c. less than 1 vol % preservatives.

In an embodiment, a concentrated spirit beverage has one, some or all of the following characteristics:
a. a consumable alcohol content from 15 vol % to 60 vol %;
b. a consumable sugar content from greater than 5 vol % to 50 vol %; and
c. less than 0.05 vol % preservatives,

In an embodiment, a concentrated spirit beverage has one, some or all of the following characteristics:
a. a consumable alcohol content from 20 vol % to 60 vol %;
b. a consumable sugar content from greater than 5 vol % to 45 vol %; and
c. less than 0.02 vol % preservatives.

In an embodiment, a concentrated spirit beverage has one, some or all of the following characteristics:
a. a consumable alcohol content from 30 vol % to 60 vol %;
b. a consumable sugar content from greater than 5 vol % to 40 vol %; and
c. less than 0.01 vol % preservatives.

The concentrated spirit beverage may be in accordance with any embodiment or combinations of embodiments described herein.

### Packaging

In an embodiment, the concentrated spirit beverage is provided in a container capable of holding from 0.5 liter, or 0.75 liter, or 1 liter, or 1.25 liters to 1.5 liters, or 1.75 liters, or 2 liters, or 2.25 liters, or 2.5 liters. The container may be of any material, shape, structure, or configuration known in the art for holding a concentrated spirit beverage. In an embodiment, the container has a “bag-in-a-box” configuration, with a plastic bag filled with the concentrated spirit beverage inside a box to give the bag shape/structure and easier and more reliable transport ability. In an embodiment, the container is capable of being connected to standard beverage dispensing systems known in the art, such as soda guns.

### Packaged Concentrated Spirit Beverage

The packaged concentrated spirit beverage is shelf stable, without refrigeration. The storage temperature of the packaged concentrated spirit beverage is therefore from above freezing (32° F.) to 100° F. Exposure to temperatures greater than 100° F. for long periods of time may change the flavor, pH or other properties of the concentrated spirit beverage.

The packaged concentrated spirit beverage is substantially free of pathogens known to be harmful to human health both at the time of packaging and for at least one year after packaging. “Substantially free of” has the same definition as set forth herein. “Pathogen” refers to any organism which does or may have a negative impact on human health when consumed in any quantity. Exemplary pathogens include, but are not limited to, viruses, bacteria, molds, prions, fungi, and the such.

### Method of Making a Concentrated Spirit Beverage

In an embodiment, the method of making a concentrated spirit beverage includes mixing an amount of consumable alcohol, consumable sugar, and water together. The consumable alcohol, consumable sugar, and water are in accordance with any embodiment or combination of embodiments described herein. Optionally, one or more natural or artificial flavorings and/or particulate matter is added to the consumable alcohol, consumable sugar, and water. If necessary, additional water may be added to achieve a target total volume, pH, consumable alcohol concentration, consumable sugar concentration, or flavor profile. The consumable alcohol, consumable sugar, water, and optional natural and artificial flavorings and/or particulate matter together form a concentrated spirit beverage. The concentrated spirit beverage is stored in a package at a temperature from above freezing to 70° F.

### Method of Mixing a Spirit Beverage

The method of mixing a spirit beverage includes the step of providing a concentrated spirit beverage in accordance with any embodiment or combination of embodiments disclosed herein. An amount of the concentrated spirit beverage is portioned into a separate container. The portioned concentrated spirit beverage is diluted using one or more consumable liquids. As used herein, a “consumable liquid” is a liquid intended for human consumption. Exemplary consumable liquids include, but are not limited to, water, soda water, seltzer water, club soda, ginger ale, sodas, pops, other carbonated beverages, tea, milk, juices, other non-carbonated beverages, and combinations thereof.

The desired diluting ratio depends on the ingredients and concentrations of those ingredients in the concentrated spirit beverage and the desired spirit beverage being created. In an embodiment, the concentrated spirit beverage is diluted with the consumable liquid at a ratio of from 2:1 (consumable liquid:concentrated spirit beverage) to 15:1 (consumable liquid:concentrated spirit beverage). In a particular embodiment, the concentrated spirit beverage is diluted with the consumable liquid at a ratio from 2 parts, or 3 parts, or 4 parts, or 5 parts to 6 parts, or 7 parts, or 8 parts, or 9 parts, or 10 parts, or 15 parts consumable liquid to 1 part concentrated spirit beverage.

In an embodiment, the particular dilution ratio depends on the desired alcohol content of the final (diluted) spirit beverage at the time of consumption. In an embodiment, the desired alcohol content of the final (diluted) spirit beverage at the time of consumption is from greater than 0% alcohol by volume (ABV) to 14% ABV and the concentrated spirit beverage is diluted with the consumable liquid at a ratio from 2 parts, or 3 parts, or 4 parts to 5 parts, or 6 parts, or 8 parts, or 10 parts, or 15 parts consumable liquid per 1 part concentrated spirit beverage. In an embodiment, the desired alcohol content of the final (diluted) spirit beverage at the time of consumption is from greater than 14 % ABV to 20% ABV and the concentrated spirit beverage is diluted with the consumable liquid at a ratio from 2 parts, or 2.5 parts to 3 parts, or 3.5 parts, or 4 parts, or 5 parts consumable liquid per 1 part concentrated spirit beverage.

In a further embodiment, the desired alcohol content of the final (diluted) spirit beverage at the time of consumption is from greater than 0% ABV to less than 10% ABV and the concentrated spirit beverage is diluted with the consumable liquid at a ratio from 2 parts, or 3 parts, or 4 parts to 5 parts, or 6 parts, or 8 parts, or 10 parts, or 15 parts consumable liquid per 1 part concentrated spirit beverage. In an embodiment, the desired alcohol content of the final (diluted) spirit beverage at the time of consumption is from 10% ABV to less than 16% ABV and the concentrated spirit beverage is diluted with the consumable liquid at a ratio from 2 parts, or 2.5 parts, or 3 parts, or 3.5 parts, or 4 parts to 4.5 parts, or 5 parts, or 5.5 parts, or 6 parts consumable liquid per 1 part concentrated spirit beverage. In an embodiment, the desired alcohol content of the final (diluted) spirit beverage at the time of consumption is from 16% ABV to 20% ABV and the concentrated spirit beverage is diluted with the consumable liquid at a ratio from 2 parts, or 2.5 parts to 3 parts, or 3.5 parts, or 4 parts consumable liquid per 1 part concentrated spirit beverage.

In an embodiment, a concentrated spirit beverage is diluted by a consumable liquid at a ratio from 2:1 consumable liquid:concentrated spirit beverage to 15:1 consumable liquid:concentrated spirit beverage and has one, some or all of the following characteristics:
a. a consumable alcohol content from 15 vol % to 60 vol %;
b. a consumable sugar content from greater than 5 vol % to 45 vol %; and
c. less than 1 vol % preservatives.

In an embodiment, a concentrated spirit beverage is diluted by a consumable liquid at a ratio from 2:1 consumable liquid:consentrated spirit beverage to 15:1 consumable liquid:concentrated spirit beverage and has one, some or all of the following characteristics:
a. a consumable alcohol content from 15 vol % to 60 vol %;
b. a consumable sugar content from greater than 5 vol % to 50 vol %; and
c. less than 0.05 vol % preservatives,

In an embodiment, a concentrated spirit beverage is diluted by a consumable liquid at a ratio from 2:1 consumable liquid:concentrated spirit beverage to 6:1 consumable liquid:concentrated spirit beverage and has one, some or all of the following characteristics:
a. a consumable alcohol content from 20 vol % to 60 vol %;
b. a consumable sugar content from greater than 5 vol % to 45 vol %; and
c. less than 0.02 vol % preservatives.

In an embodiment, a concentrated spirit beverage is diluted by a consumable liquid at a ratio from 2:1 consumable liquid:concentrated spirit beverage to 4:1 consumable liquid:concentrated spirit beverage and has one, some or all of the following characteristics:
a. a consumable alcohol content from 30 vol % to 60 vol %;
b. a consumable sugar content from greater than 5 vol % to 40 vol %; and
c. less than 0.01 vol % preservatives.

In an embodiment, the step of diluting includes connecting the concentrated spirit beverage to a consumable liquid dispenser and dispensing the concentrated spirit beverage and consumable liquid using the consumable liquid dispenser. In an embodiment, the consumable liquid dispenser is a soda gun.

From the foregoing, it will be appreciated that although specific embodiments or examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

It is specifically intended that the present invention not be limited to the embodiments, examples and illustrations contained herein, but include modified forms of those embodiments or examples including portions of the embodiments or examples and combinations of elements of different embodiments or examples as come within the scope of the following claims.

What is claimed is:

1. A concentrated spirit beverage composition comprising:
a consumable alcohol;
a consumable sugar;
water; and
optionally, one or more natural flavorings, artificial flavorings and particulate matter,
wherein the concentrated spirit beverage composition is substantially free of preservatives.

2. The composition of claim 1, wherein the consumable alcohol is present in an amount from greater than or equal to 10 vol % to less than or equal to 70 vol %.

3. The composition of claim 2, wherein the consumable alcohol is present in an amount from 15 vol % to 65 vol %.

4. The composition of claim 1, wherein the consumable sugar is present in an amount from greater than 5 vol % to 50 vol %.

5. The composition of claim 1, wherein the water is present in an amount from greater than 0 vol % to less than or equal to 55 vol %.

6. The composition of claim 1, wherein the composition comprises less than 0.1 vol % preservatives.

7. The composition of claim 6, wherein the composition comprises 0 vol % preservatives.

8. The composition of claim 1 having a pH from greater than 1 to less than 9.

9. The composition of claim 5, wherein the consumable alcohol is present in an amount from 15 vol % to 60 vol % and the consumable sugar is present in an amount from greater than 5 vol % to 50 vol %.

10. The composition of claim 1, wherein the consumable alcohol is present in an amount from 20 vol % to 60 vol % and the consumable sugar is present in an amount from greater than 5 vol % to 45 vol %.

11. The composition of claim 1, wherein the consumable alcohol is present in an amount from 25 vol % to 60 vol % and the consumable sugar is present in an amount from greater than 5 vol % to 45 vol %.

12. The composition of claim 1, wherein the consumable alcohol is present in an amount from 30 vol % to 60 vol % and the consumable sugar is present in an amount from greater than 5 vol % to 45 vol %.

13. The composition of claim 1, wherein the composition comprises at least one natural or artificial flavoring.

14. The composition of claim 13, wherein the at least one natural or artificial flavoring is present in an amount from greater than 0 vol % to 25 vol %.

15. The composition of claim 13, wherein the natural or artificial flavoring comprises citric acid, and the citric acid is present in an amount from greater than 0 vol % to less than 2 vol %.

16. The composition of claim 13, wherein the natural or artificial flavoring comprises a natural fruit juice concentrate, and the natural fruit juice concentrate is present in an amount from 5 vol % to 20 vol %.

17. A method of making a spirit beverage comprising:
providing a concentrated spirit beverage, the concentrated spirit beverage comprising
a consumable alcohol,
a consumable sugar,
water, and
optionally, one or more of a natural flavoring, an artificial flavoring, and particulate matter;
dispensing a portion of the concentrated spirit beverage; and
diluting the portion of the concentrated spirit beverage with a consumable liquid.

18. The method of claim 17, wherein the portion of the concentrated spirit beverage is diluted with the consumable liquid at a ratio of 2:1 (consumable liquid:concentrated spirit beverage) to 15:1 (consumable liquid:concentrated spirit beverage).

19. The method of claim 18, wherein:
(i) the spirit beverage has an alcohol by volume (ABV) of greater than 0% to less than 10%, the concentrated spirit beverage has a consumable alcohol content of from 15 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 15:1 (consumable liquid:concentrated spirit beverage); or
(ii) the spirit beverage has an ABV of 10% to less than or equal to 15%, the concentrated spirit beverage has a consumable alcohol content from 20 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 6:1 (consumable liquid:concentrated spirit beverage); or
(iii) the spirit beverage has an ABV of 15% to less than or equal to 25%, the concentrated spirit beverage has a consumable alcohol content from 30 vol % to 60 vol % and a consumable sugar content from greater than 5 vol % to 45 vol %, and the portion of the concentrated spirit beverage is diluted with the consumable liquid at a ratio from 2:1 (consumable liquid:concentrated spirit beverage) to 4:1 (consumable liquid:concentrated spirit beverage).

20. The method of claim 17, wherein the concentrated spirit beverage is connected to a consumable beverage dispenser for dispensing.

21. The composition of claim 9, wherein the composition comprises at least one natural or artificial flavoring.
